(19) United States
(12) Patent Application Publication
(10) Pub. No.: US 2026/0323362 A1
(43) Pub. Date: Oct. 15, 2026

(54) METHODS AND SYSTEMS FOR ENABLING AN APPLICATION FUNCTION TO INFLUENCE TRAFFIC IN A NETWORK

(71) Applicant: Telefonaktiebolaget LM Ericsson (publ), Stockholm (SE)

(72) Inventors: Magnus HALLENSTÅL, Täby (SE); Magnus OLSSON, Sigtuna (SE); Attila MIHÁLY, Dunakeszi (HU)

(73) Assignee: Telefonaktiebolaget LM Ericsson (publ), Stockholm (SE)

(21) Appl. No.: 19/483,431

(22) PCT Filed: May 7, 2024
(86) PCT No.: PCT/EP2024/062617

§ 371 Date: Nov. 11, 2025

Related U.S. Application Data
(60) Provisional application No. 63/466,121, filed on May 12, 2023.

(51) Int. Cl. H04W 28/02; H04W 4/50; H04W 8/20; H04W 84/04

(52) U.S. Cl. CPC H04W 28/0226; H04W 4/50; H04W 8/20; H04W 84/042

(57) ABSTRACT

A method (300) performed by a first network function, NF, for enabling a second NF to influence traffic in a network. The method includes receiving from the second NF a traffic influence, TI, request message comprising TI data. The method also includes, after receiving the request, obtaining a session management function, SMF, notification endpoint. And the method another includes transmitting to the SMF notification endpoint a TI notification message comprising the TI data, wherein a third network function associated with the SMF notification endpoint uses the TI data to influence traffic in the network.

### TECHNICAL FIELD

Disclosed are embodiments related to application function (AF) influence of traffic in a network.

### BACKGROUND

There are scenarios in which it is advantageous to enable an AF to influence certain traffic in a network (e.g., a 5G core network (5GC)) by, for example, influencing how the traffic is routed in the network or handled. An AF may want to influence a user equipment's (UE's) user plane (UP) traffic to maintain an efficient UP for the UE. To influence traffic, the Access & Mobility Management Function (AMF) may send requests to influence Session Management Function (SMF) routing decisions for UP traffic of Packet Data Unit (PDU) Sessions belonging to the UE. The AF requests may influence User Plane Function (UPF) selection and re-selection and allow routing of user traffic to a local access (identified by a Data Network Access Identifier (DNAI)) to a Data Network and/or influence the steering of user traffic to service function chain(s) identified by Service Function Chaining (SFC) policy identifier(s).

In the Third Generation Partnership Project (3GPP) Release 17 (Rel-17), AF influence on a UE's UP traffic could only be done when the UE is in its Home Public Land Mobile Network (HPLMN) or if local breakout is used when the UE is in a Visited Public Land Mobile Network (VPLMN). In 3GPP Release 18 (Rel-18) there is a study on how to enable AF influence when the UE is in VPLMN and the PDU session is a home routed PDU session (see 3GPP TR 23.700-48 V 18.0.0 (2022-12). A suggestion is to store traffic influence (TI) data in a UDR of the VPLMN and for the SMF in the VPLMN (i.e., V-SMF) to subscribe to this information.

### SUMMARY

Certain challenges presently exist. For instance, the AF may not know the UE's true IP address because the UE's true IP address has been Network Address Translated (NATed) and it is unclear how an SMF in the VPLMN (i.e., V-SMF) can correlate the UE's PDU session with this NATed IP address. Additionally, overlapping IP addresses may be used by several HPLMNs (e.g., from the 10.0.0.0 series), and, even within one and the same HPLMN; hence, even if the UE signals its IP address to the AF, the IP address cannot be used as a key to retrieve from a UDR TI data related to the UE because several UEs may have the same IP address. Furthermore, it is unclear how a Network Exposure Function (NEF) discovers and selects a Unified Data Repository (UDR).

Accordingly, in one aspect there is provided a method for performed by a first network function (NF) (e.g., V-NEF) for enabling a second NF (e.g., an AF) to influence traffic in a network. The method includes receiving from the second NF a traffic influence (TI) request message (e.g., Nnef_TrafficInfluence_Create message) comprising TI data. The method also includes, after receiving the request, obtaining a session management function (SMF) notification endpoint. The method further includes transmitting to the SMF notification endpoint a TI notification message comprising the TI data (i.e., transmitting the message to an address indicated by the SMF notification endpoint). A third network function (e.g., V-SMF) associated with the SMF notification endpoint uses the TI data to influence traffic in the network.

In another embodiment (e. g,. an embodiment in which the first network function is an H-NEF) the method includes receiving from a third NF (e.g., a V-NEF) a first information request message. The method also includes, after receiving the first information request message, using certain information included in the first information request message to obtain a session management function (SMF) notification endpoint. The method also includes transmitting to the third NF a response message responsive to the first information request message, wherein the response message comprises the SMF notification endpoint.

In another aspect there is provided a method for providing visited Public Land Mobile Network (PLMN) information related to a home routed (HR) session (e.g., an HR-PDU session). The method includes a first NF in a home PLMN (HPLMN) (e.g., an H-SMF), storing the VPLMN information (e.g., the VPLMN information may comprise a notification endpoint for an SMF in the VPLMN). The method also includes the first NF receiving from a second NF (e.g., an H-NEF) an information request message. The method further includes the first NF transmitting to the second NF a response message responsive to the information request message, wherein the response message comprises the VPLMN information related to the HR session.

In another aspect there is provided a computer program comprising instructions which when executed by processing circuitry of a network node causes the network node to perform any of the methods disclosed herein. In one embodiment, there is provided a carrier containing the computer program wherein the carrier is one of an electronic signal, an optical signal, a radio signal, and a computer readable storage medium. In another aspect there is provided a network node that is configured to perform the methods disclosed herein. The network node may include memory and processing circuitry coupled to the memory.

An advantage of the embodiments disclosed herein is that they remedy the above described issues. Moreover, less processing and storage is needed because the UDR in the VPLMN is not used for storing the traffic influence (TI) data.

### BRIEF DESCRIPTION OF THE DRAWINGS

The accompanying drawings, which are incorporated herein and form part of the specification, illustrate various embodiments.

FIG. 1 illustrates a system according to an embodiment.

FIG. 2 is a signaling diagram according to an embodiment.

FIG. 3 is a flowchart illustrating a process according to an embodiment.

FIG. 4 is a flowchart illustrating a process according to an embodiment.

FIG. 5 is a flowchart illustrating a process according to an embodiment.

FIG. 6 is a block diagram of a network node according to an embodiment.

### DETAILED DESCRIPTION

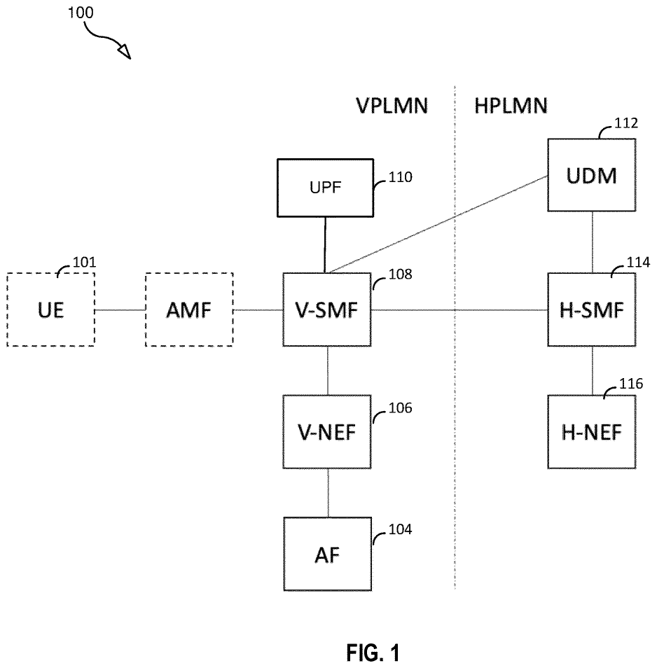

FIG. 1 illustrates a system 100 according to an embodiment. System 100 includes a VPLMN and a HPLMN, and each PLMN contains several network functions. For instance, as shown in FIG. 1, HPLMN includes a Unified Data Management function (UDM) 112, an SMF (denoted H-SMF) 114, and an NEF (denoted H-NEF) 116. Similarly, VPLMN includes an AF 104, an NEF (denoted V-NEF) 106, an SMF (denoted V-SMF) 108, a UPF 110, and an Access Mobility and Management Function (AMF), which serves UEs such as a UE 101.

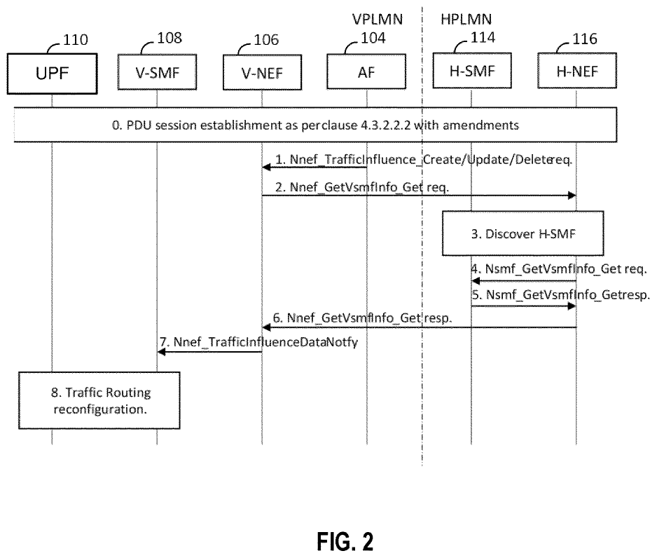

FIG. 2 is a signaling diagram illustrating a process for AF influence of traffic, according to an embodiment.

### Step 0

In this step, a PDU session for a UE is established as described clause 4.3.2.2.2 of 3GPP Technical Specification (TS) 23.502 V 18.1.1 (“TS 23.502”) with the following changes. During the PDU session establishment procedure as described in clause 4.3.2.2.2 of TS 23.502, V-SMF 108 invokes the Nsmf_PDUSession_Create Request service operation (i.e., the V-SMF sends a request message to H-SMF 114). In one embodiment (e.g., where the V-SMF is HR-SBO capable), V-SMF 108 includes its notification endpoint for traffic influence data in the Nsmf_PDU_session_Create request message sent to H-SMF 114. This serves as an implicit subscription for AF influence of traffic. The H-SMF 114 will store the V-SMF's notification endpoint together with the PDU session ID for the PDU session and/or the Subscription Permanent Identifier (SUPI) associated with the UE so that the notification endpoint can be retrieved later in response to an information request from another NF where the information request includes the PDU session ID and/or SUPI (or includes information that enables the H-SMF to obtain the PDU session ID and/or SUPI) (e.g., retrieved by H-SMF 114 in response to an information request transmitted by H-NEF 116 (see, e.g., step 4 below)). In one embodiment, the V-SMF's notification endpoint comprises an address (e.g., IP address or domain name) assigned to V-SMF 108 (i.e., the notification endpoint identifies a V-SMF) and a notification correlation identifier (ID). For instance, the notification endpoint may be a Uniform Resource Identifier (URI), such as a Uniform Resource Locator (URL), that includes an address allocated to V-SMF 108 and the notification correlation ID.

### Step 1

The AF 104 invokes an Nnef TrafficInfluence service operation. More specifically, to create a new request, the AF 104 invokes a Nnef_TrafficInfluence_Create service operation (i.e., AF 104 transmits to V-NEF 106 a Nnef_TrafficInfluence_Create request message). The content of this request message (a.k.a., “AF request”) is defined in clause 5.2.6.7 of TS 23.502. To update or remove an existing request, the AF invokes a Nnef_TrafficInfluence_Update or Nnef_TrafficInfluence_Delete service operation providing the corresponding AF Transaction Id. The Nnef_TrafficInfluence_Create (initiated by target AF) or Nnef_TrafficInfluence_Update (initiated by source AF or target AF) service operation may be used for the case of AF instance change. The Nnef_TrafficInfluence_Update service operation may include an updated notification target address. The updated subscription resource is used by the target AF.

According to clause 5.2.6.7 of TS 23.502, the Nnef_TrafficInfluence Create request message must include: AF Transaction Id, AF Identifier. The Nnef TrafficInfluence_Create request message may include: the address (IP or Ethernet) of one or more UE(s) if available, one or more Generic Public Subscription Identifiers (GPSIs) if available, Data Network Name (DNN) if available, Single Network Slice Selection Assistance Information (S-NSSAI) if available, External Group Identifier(s) if available, External Application Identifier or traffic filtering information, AF-Service-Identifier, a list of Data Network Access Identifier(s) (DNAI(s)) and corresponding routing profile ID(s) or N6 traffic routing information, Indication of traffic correlation, Indication of application relocation possibility, Indication of UE IP address preservation, Early and/or late notifications about UP path management events, Notification Target Address, immediate reporting flag, Temporal validity condition, Spatial validity condition, User Plane Latency Requirements, Information for Edge Application Servers (EAS) IP Replacement in 5GC, Indication for EAS Relocation and AF indication for simultaneous connectivity over source and target PDU Session Anchor (PSA) at edge relocation, EAS Correlation indication, External Subscriber Category(s), SFC Policy Identifier(s), Metadata, Common EAS IP address, Traffic Correlation ID, Fully Qualified Domain Name(s) (FQDN(s)).

When only one DNAI and corresponding routing profile ID(s) and the Indication for EAS Relocation are available, the presented DNAI is the target DNAI.

In one embodiment, the following cannot be used by AFs in VPLMN influencing traffic on Home Routed PDU sessions: External Group Identifier and External Subscriber Category.

### Step 2

V-NEF 106 receives the request from AMF 104 and then discovers and selects an H-NEF (e.g., H-NEF 116 in this example) supporting Nnef_GetVsmfInfo service operation and sends to the selected H-NEF 116 the Nnef_GetVsmfInfo Get request message, which contains UE address (e.g., an IP address or a tuple comprising an IP address and port number), S-NSSAI, DNN (V-NEF 106 may obtain the UE address, S-NSSAI, and DNN from the Nnef TrafficInfluence_Create request message transmitted by AF 104 in step 1). This Nnef GetVsmfInfo request message also serves as informing HPLMN about AF influence of traffic in VPLMN.

### Step 3

After receiving the Nnef_GetVsmfInfo request message, H-NEF 116 discovers an H-SMF (e.g., H-SMF 114 in this example) using the received information (e.g., using UE address, S-NSSAI, DNN). For example, the H-NEF uses the information to retrieve the SUPI for the UE (e.g., by first executing steps 3 to 8 in clause 4.15.10 of TS 23.502) and then using Nudm UECM_Get service operation sends to a UDM a get request message containing the SUPI to get from the UDM an SMF identifier identifying the serving H-SMF (e.g., an address or name of the serving H-SMF) and PDU session ID associated with the SUPI.

### Step 4

After discovering H-SMF 114, H-NEF 116 invokes Nsmf_GetVsmfInfo service operation (i.e., sends to the H-SMF an Nsmf_Get VsmfInfo_Get request message containing the PDU session ID and SUPI) to retrieve from the H-SMF the V-SMF notification endpoint for the Nnef TrafficInfluenceData service. As noted above, the H-SMF may obtain the V-SMF notification endpoint during the PDU establishment procedure.

### Step 5

H-SMF 114 responds to the request received in step 4 by sending to H-NEF 116 a response message (e. g,. Nsmf_GetVsmfInfo_Get response) with the V-SMF notification endpoint to be used for traffic influence data. For example, H-SMF 114 uses the PDU session ID and/or SUPI received from the message sent in step 4 to retrieve the V-SMF notification endpoint that is associated with the PDU session ID and/or SUPI and includes this retrieved V-SMF notification endpoint in the Nsmf_GetVsmfInfo_Get response message.

### Step 6

After receiving from H-SMF 114 the response message containing the V-SMF notification endpoint, H-NEF 116 responds to the request in step 2 by sending to V-NEF 106 a response message (e.g., Nnef_GetVsmfInfo_Get response) responsive to the request in step 2, where the Nnef_GetVsmfInfo_Get response message contains the V-SMF notification endpoint.

### Step 7

After receiving the response message from H-NEF 116, V-NEF 106 sends to the V-SMF identified by the V-SMF notification endpoint (i.e., V-SMF 108 in this example) a notification message (e.g., Nnef_TrafficInfluenceDataNotify message) containing TI data (e.g., the TI data provided by AF 104 to V-NEF 106 in step 1). The notification message also includes the endpoint of Nnef_TrafficInfluenceData service and the subscription correlation ID included in the V-SMF notification endpoint (related to the AF request from step 1). Using the notification correlation ID, V-SMF 108 can determine (e.g., look-up) the PDU session for which the TI data is intended.

### Step 8

V-SMF 108 takes one or more actions related to the TI data received in the notification message. Examples of these actions include:
(1) Determining a target DNAI and adding, replacing or removing a UPF in the data path to e.g. act as an Uplink Classifier (UL CL) or a Branching Point e.g. as described in clause 4.3.5 of TS 23.502;
(2) Allocating a new Prefix to the UE (when IPv6 multi-Homing applies);
(3) Updating the UPF in the target DNAI/Common DNAI with new traffic steering rules;
(4) Subscribing to notifications from the AMF for an Area of Interest via Namf EventExposure_Subscribe service operation; and
(5) Determining whether to relocate PSA UPF considering the user plane latency requirements provided by the AF (see clause 6.3.6 of 3GPP TS 23.548V 18.1.1 ).

### Nnef GetVsmfInfo Service

This service allows for an NF consumer e.g. NEF in VPLMN to get the Notification endpoint for Traffic Influence of the V-SMF.

The Nnef_GetVsmfInfo Service supports the Nnef_GetVsmfInfo_Get operation. This operation is used for retrieving the Notification endpoint of V-SMF for Traffic Influence in the VPLMN The Inputs are: DNN, S-NSSAI, UE address (e.g., IP address or IP address plus Port number).

The Outputs are: Notification endpoint for Traffic Influence in the VPLMN.

### Nsmf GetVsmfInfo Service

This service allows for an NF consumer e.g. NEF to get the Notification endpoint for Traffic Influence of the V-SMF.

The Nsmf GetVsmfInfo Service supports the Nsmf_GetVsmfInfo_Get operation. This operation is used for retrieving the Notification endpoint of V-SMF for Traffic Influence in the VPLMN. The inputs are PDU session ID and SUPI. The outputs are Notification endpoint for Traffic Influence in the VPLMN.

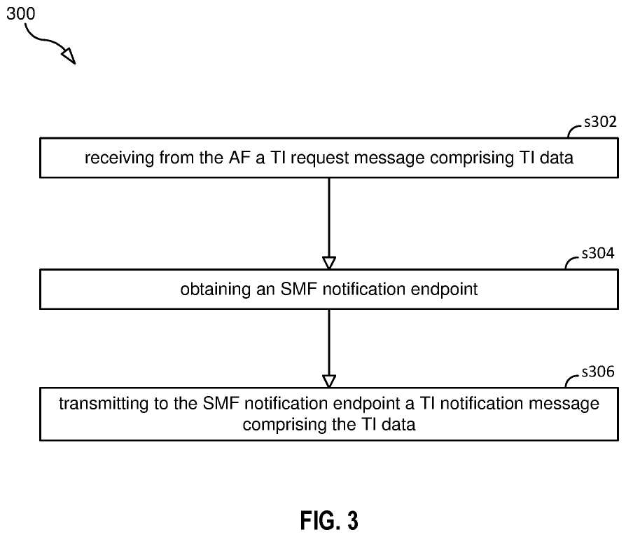

FIG. 3 is a flow chart illustrating a process 300, according to an embodiment, for enabling an AF to influence traffic in a network. Process 300 is performed by a first NF (e.g., V-NEF 106) and may begin in step s302.

Step s302 comprises receiving from the AF a TI request message (e.g., Nnef TrafficInfluence_Create message) comprising TI data (e.g., the data included in the message sent by AF 104 in step 1 described above, such as, for example, a DNAI for a given traffic to be broken out, latency information specifying a latency requirement to be fulfilled, etc.).

Step s304 comprises, after receiving the request, obtaining a session management function, SMF, notification endpoint.

Step s306 comprises transmitting to the SMF notification endpoint a TI notification message comprising the TI data. That is, the first NF transmits the TI notification message to an address indicated by (e.g., included in) the SMF notification endpoint. A third NF (e.g., V-SMF 108) associated with the SMF notification endpoint (e.g., a third NF to which the address is allocated and which, thereby, receives the TI notification message) uses the TI data to influence traffic in the network.

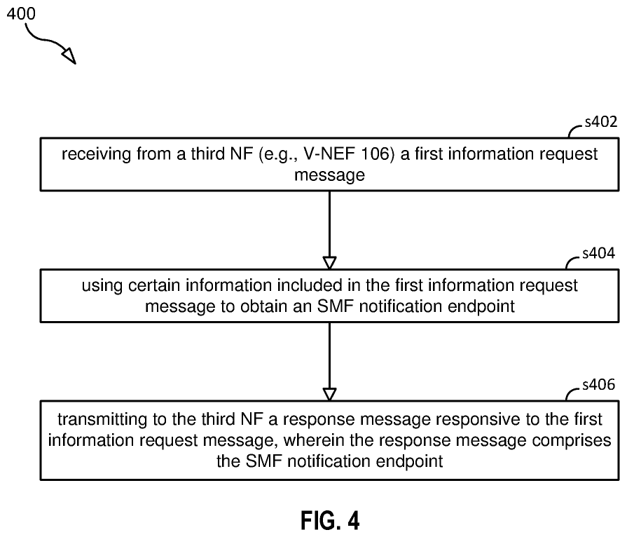

FIG. 4 is a flow chart illustrating a process 400, according to an embodiment, for enabling an AF to influence traffic in a network. Process 400 is performed by a first NF (e.g., H-NEF 116) and may begin in step s402.

Step s402 comprises receiving from a third NF (e.g., V-NEF 106) a first information request message.

Step s404 comprises, after receiving the first information request message, using certain information included in the first information request message to obtain a SMF notification endpoint.

Step s406 comprises transmitting to the third NF a response message responsive to the first information request message, wherein the response message comprises the SMF notification endpoint.

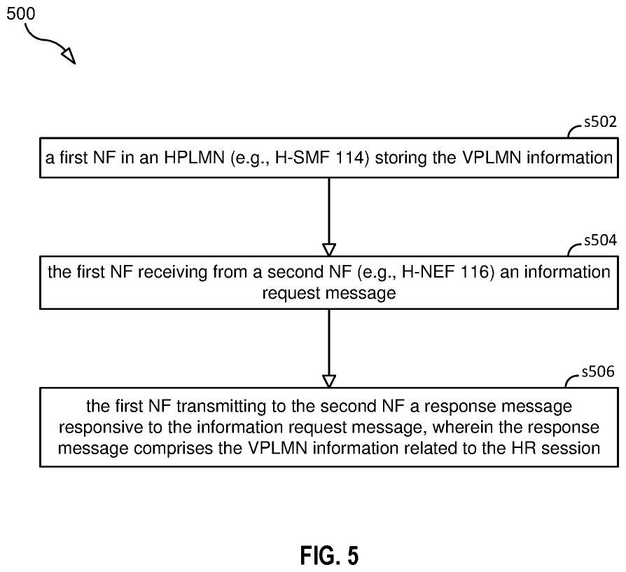

FIG. 5 is a flow chart illustrating a process 500, according to an embodiment, for providing VPLMN information related to an HR session (e.g., HR-PDU session). Process 500 may begin in step s502.

Step s502 comprises a first NF in an HPLMN (e.g., H-SMF 114) storing the VPLMN information (e.g., the VPLMN information may comprise a notification endpoint for an SMF in the VPLMN).

Step s504 comprises the first NF receiving from a second NF (e.g., H-NEF 116) an information request message.

Step s506 comprises the first NF transmitting to the second NF a response message responsive to the information request message, wherein the response message comprises the VPLMN information related to the HR session.

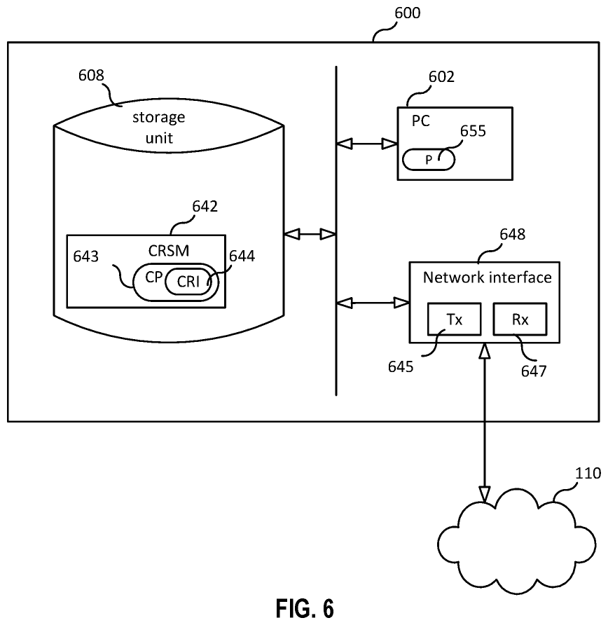

FIG. 6 is a block diagram of network node 600, according to some embodiments. Network node 600 may be used to implement any one of the network function described above, including, for example, V-NEF 106, H-NEF 116, H-SMF 114. As shown in FIG. 6, network node 600 may comprise: processing circuitry (PC) 602, which may include one or more processors (P) 655 (e.g., one or more general purpose microprocessors and/or one or more other processors, such as an application specific integrated circuit (ASIC), field-programmable gate arrays (FPGAs), and the like), which processors may be co-located in a single housing or in a single data center or may be geographically distributed (i.e., network node 600 may be a distributed computing apparatus); at least one network interface 648 (e.g., a physical interface or air interface) comprising a transmitter (Tx) 645 and a receiver (Rx) 647 for enabling network node 600 to transmit data to and receive data from other nodes connected to network 110 (e.g., an Internet Protocol (IP) network) to which network interface 648 is connected (physically or wirelessly) (e.g., network interface 648 may be coupled to an antenna arrangement comprising one or more antennas for enabling network node 600 to wirelessly transmit/receive data); and a storage unit (a.k.a., “data storage system”) 608, which may include one or more non-volatile storage devices and/or one or more volatile storage devices. In embodiments where PC 602 includes a programmable processor, a computer readable storage medium (CRSM) 642 may be provided. CRSM 642 may store a computer program (CP) 643 comprising computer readable instructions (CRI) 644. CRSM 642 may be a non-transitory computer readable medium, such as, magnetic media (e.g., a hard disk), optical media, memory devices (e.g., random access memory, flash memory), and the like. In some embodiments, the CRI 644 of computer program 643 is configured such that when executed by PC 602, the CRI causes network node 600 to perform steps described herein (e.g., steps described herein with reference to the flow charts). In other embodiments, network node 600 may be configured to perform steps described herein without the need for code. That is, for example, PC 602 may consist merely of one or more ASICs.

Hence, the features of the embodiments described herein may be implemented in hardware and/or software.

### EXAMPLE EMBODIMENTS

A1. A method 300 (see FIG. 3) performed by a first network function (NF) (e.g., V-NEF 106) for enabling a second NF (e.g., application function (AF)) to influence traffic in a network, the method comprising:
receiving from the second NF a traffic influence, TI, request message (e.g., Nnef TrafficInfluence_Create message) comprising TI data;
after receiving the request, obtaining a session management function, SMF, notification endpoint; and
transmitting to the SMF notification endpoint a TI notification message comprising the TI data, wherein a third network function (e.g., V-SMF 108) associated with the SMF notification endpoint uses the TI data to influence traffic in the network.
A2. The method of embodiment A1, wherein obtaining the SMF notification endpoint comprises:
transmitting to a fourth network function (e.g., H-NEF 116) an information request message; and
receiving from the fourth network function a response message responsive to the information request message, wherein the response message comprises the SMF notification endpoint.
A3. The method of embodiment A2, wherein
the TI request message comprises a user equipment (UE) address, a network slice identifier (e.g., S-NSSAI), and a network name (e.g., DNN), and
the information request message comprises the UE address, the network slice identifier, and the network name.
A4. The method of any one of embodiments A1-A3, wherein the TI notification message further comprises an endpoint of a TI data service and a subscription correlation identifier.
B1. A method 400 (see FIG. 4) performed by a first network function (NF) (e.g., H-NEF 116) for enabling a second NF (e.g., application function (AF)) to influence traffic in a network, the method comprising:
receiving from a third NF (e.g., V-NEF) a first information request message; after receiving the first information request message, using certain information included in the first information request message to obtain a session management function, SMF, notification endpoint; and transmitting to the third NF a response message responsive to the first information request message, wherein the response message comprises the SMF notification endpoint.
B2. The method of embodiment B1, wherein using the certain information included in the information request message to obtain the SMF notification endpoint comprises:
using the certain information included in the first information request message to obtain a session identifier (e.g., PDU session ID) and subscription identifier (e.g., SUPI);
transmitting to a fourth NF (e.g., H-SMF 114) a second information request message comprising the session identifier and the subscription idenifier; and receiving from the further NF a second response message responsive to the second information request message, wherein the second response message comprises the SMF notification endpoint.
B3. The method of embodiment B2, wherein the certain information included in the first information request message comprises a user equipment address (e.g., an IP address or a tuple comprising an IP address and port number), a network slice identifier (e.g., S-NSSAI), and a network name (e.g., DNN).
B4. The method of any one of embodiments B1-B3, wherein
the network is a visited Public Land Mobile Network, VPLMN,
the first network function is a network exposure function, NEF, in a home HPLMN, and
the third network function is a NEF in the VPLMN.
C1. A method 500 (see FIG. 5) for providing visited Public Land Mobile Network, PLMN, information related to a home routed, HR, session (e.g., HR-PDU session), the method comprising:
a first network function, NF, in a home PLMN, HPLMN (e.g., H-SMF 114), storing the VPLMN information (e.g., the VPLMN information may comprise a notification endpoint for an SMF in the VPLMN);
the first NF receiving from a second NF (e.g., H-NEF 116) an information request message; and
the first NF transmitting to the second NF a response message responsive to the information request message, wherein the response message comprises the VPLMN information related to the HR session.
C2. The method of embodiment C1, wherein
the information request comprises a session identifier (e.g., PDU session ID) and/or SUPI, and
prior to transmitting the response message, the first NF uses the session ID and/or SUPI to retrieve the VPLMN information.
C3. The method of embodiment C2, further comprising: prior to storing the VPLMN information related to the HR session, receiving from a third NF in the visited PLMN (e.g., V-SMF 108) a message comprising the VPLMN information.
C4. The method of embodiment C3, wherein the message received from the third NF in the visited PLMN further comprises the session ID and/or the SUPI.
D1. A computer program (643) comprising instructions (644) which when executed by processing circuitry (602) of a network node (600) causes the network node to perform the method of any one of claims A1-A4 or B1-B3 or C1-C4.
D2. A carrier containing the computer program of embodiment D1, wherein the carrier is one of an electronic signal, an optical signal, a radio signal, and a computer readable storage medium (642).
E1. A network node (600), wherein the network node is configured to perform the method of any one of the above embodiments.

### Conclusion

This disclosure describes embodiments enabling an AF in a VPLMN to influence traffic (TI) for a HR PDU session. These embodiments do not suffer from the problems associated with the previous suggestions to store TI information in UDR and for SMF to subscribe to this information.

Additionally, several of the steps described in clause 4.3.6.2 of TS of 23.502 are no longer needed (such as, for example, step 0a, step 0b-1, step 0b-2, step 4b, and step 5b).

Hence, with respect to the procedure shown in FIG. 4.3.6.2-1 of TS of 23.502, the PCF need not subscribe to modifications of AF requests from the UDR; V-SMF supporting HR-SBO need not subscribe to notification of AF request by invoking Nnef_TrafficInfluenceData Subscribe service (hence the V-NEF need not notify the V-SMF of AF influence request information); and the V-NEF need not subscribe to notification of AF request from V-UDR (hence V-UDR will not need to notify the V-NEF of AF traffic influence request information).

While various embodiments are described herein, it should be understood that they have been presented by way of example only, and not limitation. Thus, the breadth and scope of this disclosure should not be limited by any of the above-described exemplary embodiments. Moreover, any combination of the above-described elements in all possible variations thereof is encompassed by the disclosure unless otherwise indicated herein or otherwise clearly contradicted by context.

As used herein transmitting a message “to” or “toward” an intended recipient encompasses transmitting the message directly to the intended recipient or transmitting the message indirectly to the intended recipient (i.e., one or more other nodes are used to relay the message from the source node to the intended recipient). Likewise, as used herein receiving a message “from” a sender encompasses receiving the message directly from the sender or indirectly from the sender (i.e., one or more nodes are used to relay the message from the sender to the receiving node). Further, as used herein “a” means “at least one” or “one or more.”

Additionally, while the processes described above and illustrated in the drawings are shown as a sequence of steps, this was done solely for the sake of illustration. Accordingly, it is contemplated that some steps may be added, some steps may be omitted, the order of the steps may be re-arranged, and some steps may be performed in parallel.

1. A method performed by a first network function, (NF) for enabling a second NF to influence traffic in a network, the method comprising:
receiving from the second NF a traffic influence (TI) request message comprising TI data;
after receiving the request, obtaining a session management function (SMF) notification endpoint; and
transmitting to the SMF notification endpoint a TI notification message comprising the TI data, wherein
a third network function associated with the SMF notification endpoint uses the TI data to influence traffic in the network.

2. The method of claim 1, wherein obtaining the SMF notification endpoint comprises:
transmitting to a fourth network function an information request message; and
receiving from the fourth network function a response message responsive to the information request message, and
the response message comprises the SMF notification endpoint.

3. The method of claim 2, wherein
the TI request message comprises a user equipment (UE) address, a network slice identifier, and a network name, and
the information request message comprises the UE address, the network slice identifier, and the network name.

4. The method of claim 1, wherein the TI notification message further comprises an endpoint of a TI data service and a subscription correlation identifier.

5. The method of claim 1, wherein
the first NF is a network exposure function (NEF) in a visited Public Land Mobile Network (VPLMN),
the second NF is an Application Function,
the third NF is an SMF in a VPLMN, and
the fourth NF is a NEF in a home Public Land Mobile Network (HPLMN).

6. A method performed by a first network function (NF) for enabling a second NF to influence traffic in a network, the method comprising:
receiving from a third NF a first information request message;
after receiving the first information request message, using certain information included in the first information request message to obtain a session management function (SMF) notification endpoint; and
transmitting to the third NF a response message responsive to the first information request message, wherein
the response message comprises the SMF notification endpoint.

7. The method of claim 6, wherein
using the certain information included in the information request message to obtain the SMF notification endpoint comprises:
using the certain information included in the first information request message to obtain a session identifier and subscription identifier;
transmitting to a fourth NF a second information request message comprising the session identifier and the subscription identifier; and
receiving from the further NF a second response message responsive to the second information request message, and
the second response message comprises the SMF notification endpoint.

8. The method of claim 7, wherein the certain information included in the first information request message comprises a user equipment address, a network slice identifier, and a network name.

9. The method of claim 6, wherein
the network is a visited Public Land Mobile Network (VPLMN),
the first network function is a network exposure function (NEF) in a home Public Land Mobile Network (HPLMN), and
the third network function is a NEF in the VPLMN.

10. A method for providing visited Public Land Mobile Network (PLMN) information related to a home routed (HR) session, the method comprising:
a first network function (NF) in a home PLMN (HPLMN) storing the VPLMN-visited PLMN (VPLMN) information;
the first NF receiving from a second NF an information request message; and
the first NF transmitting to the second NF a response message responsive to the information request message, wherein
the response message comprises the VPLMN information related to the HR session.

11. The method of claim 10, wherein
the information request comprises a session identifier and/or a subscriber permanent identifier (SUPI), and
prior to transmitting the response message, the first NF uses a session ID and/or the SUPI to retrieve the VPLMN information.

12. The method of claim 11, wherein
the method further comprises, prior to storing the VPLMN information related to the HR session, receiving from a third NF in the visited PLMN a message comprising the VPLMN information.

13. The method of claim 12, wherein the message received from the third NF further comprises the session ID and/or the SUPI.

14. A non-transitory computer readable storage medium storing a computer program comprising instructions which when executed by processing circuitry of a network node causes the network node to perform the method of claim 1.

15. (canceled)

16. A network node comprising:
one or more processors; and
one or more memories comprising computer program codes,
the one or more memories and the computer program codes configured to, with the one or more processors, cause the network node to perform a method comprising:
receiving from the second NF a traffic influence (TI) request message comprising TI data;
after receiving the request, obtaining a session management function (SMF) notification endpoint; and
transmitting to the SMF notification endpoint a TI notification message comprising the TI data, wherein
a third network function associated with the SMF notification endpoint uses the TI data to influence traffic in the network.

17. The network node according to claim 16, wherein
obtaining the SMF notification endpoint comprises:
transmitting to a fourth network function an information request message; and
receiving from the fourth network function a response message responsive to the information request message, and
the response message comprises the SMF notification endpoint.

18. network node, comprising:
one or more processors; and
one or more memories comprising computer program codes,
the one or more memories and the computer program codes configured to, with the one or more processors, cause the network node to perform the method of claim 6.

19. (canceled)

20. A network node comprising:
one or more processors and
one or more memories comprising computer program codes,
the one or more memories and the computer program codes configured to, with the one or more processors, cause the network node to perform the method of claim 10.

21. (canceled)
